(19) United States
(12) Patent Application Publication
(10) Pub. No.: US 2022/0057363 A1
(43) Pub. Date: Feb. 24, 2022

(54) ION MOBILITY SEPARATION SYSTEM WITH ROTATING FIELD CONFINEMENT

(71) Applicant: Bruker Daltonik GmbH, Bremen (DE)

(72) Inventor: Aneesh PRABHAKARAN, Bremen (DE)

(21) Appl. No.: 16/998,174

(22) Filed: Aug. 20, 2020

(51) Int. Cl. G01N 27/62; H01J 49/06; H01J 49/10; H01J 49/24; H01J 49/00; H01J 49/42

(52) U.S. Cl. CPC G01N 27/622; H01J 49/06; H01J 49/4215; H01J 49/24; H01J 49/004; H01J 49/10

(57) ABSTRACT

An ion mobility separator includes an ion path with a central axis along which ions travel, the ion path containing a gas. A first force is applied to the ions in a first axial direction, and a second force that varies spatially along the ion path is applied to the ions in second axial direction opposite the first axial direction. A rotating confinement field has a radially-inhomogeneous electric potential with relative maxima and minima that rotate about the central axis as a function of time, the confinement field exerting a radial confinement force on the ions in a radial direction toward the central axis. The ion mobility separator may be operated at elevated pressures including ambient pressure and higher. The first and/or second axial forces may be a constant or gradient gas flow, a constant or gradient electric field or an axial component of the rotating confinement field.

### BACKGROUND OF THE INVENTION

### Field of the Invention

This invention relates generally to the field of ion mobility spectrometry and, more specifically, to trapped ion mobility spectrometry (TIMS), and to hybrid systems coupling ion mobility spectrometry and mass spectrometry.

### Description of the Related Art

Ion mobility spectrometry (IMS) is an analytical technique that is used to investigate the mobility of ions in a buffer gas and to separate them according to their mobility. An inherent feature of ion mobility spectrometry is that the mobility of ions in a buffer gas depends on molecular geometries of the ions such that it is often possible to resolve and thus separate isomers or conformers that cannot be resolved by mass spectrometry. Many applications also take advantage of the ability to determine the cross section of an analyte ion from its measured mobility. Knowledge of cross sections has proven to be significant in many areas including identifying compound class and detailed structure, in particular in the field of structural biology.

In trapped ion mobility spectrometry (TIMS), ions are trapped along a non-uniform electric DC field, typically an electric field gradient, by a counteracting gas flow, or along a uniform electric DC field by a counteracting gas flow which has a non-uniform axial velocity profile. The trapped ions are separated in space according to ion mobility, and are subsequently eluted over time according to their mobility by either the gas velocity or the strength of the axial electric DC field (see, e.g., U.S. Pat. No. 6,630,662 B1 by Loboda and U.S. Pat. No. 7,838,826 B1 by Park). A TIMS analyzer is operated in the low pressure range of 2 to 500 Pa and uses an electric RF field for radially confining the ions. The theoretical basis of TIMS is also described, for example, in the article “Fundamentals of Trapped Ion Mobility Spectrometry” by Michelmann et al. (J. Am. Soc. Mass Spectrom., 2015, 26, 14-24).

U.S. Pat. No. 9,683,964 (Park et. al) teaches a TIMS analyzer comprising a trapping region and a separating region for parallel accumulation. The TIMS analyzer accumulates ions in the trapping region while pre-accumulated ions are analyzed in the separating region parallel in time. A gas flow drives ions against a ramp of a counteracting electric DC field barrier of the trapping region such that the ions are axially trapped and get separated according to their mobility at locations along the ramp. During the accumulation of ions in the trapping region, the gas flow also drives ions, which have been accumulated in a prior accumulation and transferred to the separating region, against a ramp of a counteracting electric DC field barrier of the separating region such that the ions get axially trapped and spatially separated according to their mobility. After loading the separating region with accumulated ions to be analyzed, the height of the counteracting electric DC field barrier is steadily decreased such that ion species are released from the separating region in the sequence of their mobility.

It is known that the mobility resolution of a TIMS system increases with gas velocity, pressure and scan time. As mentioned above, conventional TIMS analyzers typically operate at pressures of 500 Pa or lower, which places them close to the minimum of the Paschen curve, which corresponds to a minimum breakdown voltage. The maximum gas velocity used in a TIMS system is limited by the magnitude of the electrical counteracting force, which must be high enough to compensate for higher gas velocities. Thus, the low pressure operation limits the mobility resolution of the TIMS system and thus the scan time.

In general, the operation of a TIMS analyzer at elevated pressure would enable higher mobility resolution as well as selecting ion species of interest at an increased repetition rate without reducing selectivity compared to operation at lower pressure. This would, in turn, allow for use of a much higher ion current from the ion sources, which would lead to a lower limit of detection. Systems that operate at pressures as high as 5000 Pa have been developed but, as the pressure is increased further, problems arise from ion loss due to a radial deviation of ions within the TIMS, as ions are destroyed due to their making contact with surrounding surfaces.

Radial confinement of ions within a TIMS is done conventionally using an electric radio frequency (RF) field that surrounds the ions within the TIMS analyzer. Published U.S. Patent Application 2017/0350860 (Raether et al.) teaches that the radially confining electric RF field of a TIMS analyzer can at least partly be an hexapolar, octopolar or higher order electric RF field. However, these radial confinements systems are limited in their ability to prevent ion loss and this, in turn, limits the performance of TIMS systems in general.

### SUMMARY OF THE INVENTION

In accordance with a first aspect of the present invention, a trapped ion mobility separator has an ion path along which ions travel through a gas from an entrance to an exit along a first axial direction relative to a central axis of the ion path. A first force-generating apparatus is provided that exerts a first force on the ions in the first axial direction. A second force-generating apparatus is also provided, and exerts a second force on the ions in a second axial direction opposite to the first axial direction. At least one of the first and second forces varies spatially along the first axial direction such that the ions are trapped and separated by ion mobility along the first axial direction during an accumulation phase. During a subsequent elution phase, at least one of the first and second forces is varied to increase a magnitude of the first force relative to the second force over time, such that the ions are progressively driven to the exit of the ion path as a function of ion mobility. A rotating confinement field-generating apparatus is also provided that generates a radially-inhomogeneous electrical potential that exerts a confinement force on the ions in a radial direction toward the central axis, with relative minima and maxima of the electrical potential rotating about the central axis as a function of time.

The first and second axial forces may be generated in different ways. Either the first force or the second force may be generated by a gas flow, and the gas flow may have a constant velocity along the length of the ion path, or the gas velocity may be a spatial gradient, varying along the ion path. Either the first force or the second force may also be an electric DC field, and the field strength may be constant along the length of the ion path, or it may be a spatial gradient, varying along the ion path. Thus, a constant gas flow in the first axial direction may be opposed by a gradient electric DC field in the second axial direction, or a gradient gas flow in the first axial direction may be opposed by a constant electric DC field in the second axial direction. Similarly, a constant gas flow in the second axial direction may be opposed by a gradient electric DC field in the first axial direction, or a gradient gas flow in the second axial direction may be opposed by a constant electric DC field in the first axial direction. In each of these cases, ions will be trapped and separated by ion mobility along the ion path, and the rotating confinement field will urge them toward the central axis.

In an exemplary embodiment, the rotating confinement field is generated by applying electrical potentials to a series of radially-segmented electrodes arranged along the axial direction of the ion path, and centered about the central axis. An exemplary embodiment uses electrodes with at least four radial segments, preferably six radial segments, more preferably eight radial segments, although more segments may also be used. Each of the segments of each electrode may be individually energized, and is provided with a high electrical potential or a low electrical potential, wherein the high electrical potential is preferably more repulsive to the ions to be confined than the low electrical potential. The distribution of the energized/deenergized segments is shifted continuously in a first rotational direction with a predetermined frequency f_{RoF} (angular frequency), such that the electric field generated by the energized segments rotates about the central axis. A specific minimum or maximum of the generated electrical potential rotates once about the central axis in a time period T_{RoF} wherein f_{RoF}=1/T_{RoF}. The distribution of energized and deenergized segments for each electrode may be symmetrical or asymmetrical with respect to the central axis at any given point in time. The distribution of energized and deenergized segments can be identical several times during the time period T_{RoF} if the distribution is rotationally symmetric under an angle of less than 360°. If the distribution of the energized/deenergized segments and the rotational frequency is identical for all of the electrodes, the effective electric field force is entirely in the radial direction.

In certain embodiments of the invention, no gas flow is used. With a resting gas located in the ion path, opposing electric field forces cause the ions to separate by ion mobility. In one version of the invention that has no gas flow, one of the two opposing forces is provided by an axial force component of the rotating confinement field. In this arrangement, the distribution of the energized/deenergized segments is rotationally offset for the different electrodes in a progressive manner along the axial direction. This offset creates an axial electric field component in addition to the radial confinement field. This axial field component may therefore function as one of the two counteracting axial forces, being opposed, for example, by a gradient electric DC field in the opposite axial direction.

In an exemplary embodiment of the invention, the axial force that varies spatially along the first axial direction may be generated so that it varies along the direction of ion travel only up to an elution point, at which it flattens to a plateau of substantially constant force that continues near to or even up to the exit of the ion separator. In such an embodiment, trapping and/or separation of the ions occurs prior to the elution point, and during the elution phase, as one of the two forces is changed with time, the ion species of different ion mobility are shifted toward the elution point. Each ion species then sequentially arrives at the elution point, and the net force on that ion species is sufficient to allow it to exit past the elution point and exit the ion separator.

The trapped ion mobility separator may be arranged such that

$${K}_{o} \frac{{p}_{o}}{p} \frac{T}{{T}_{o}} \frac{m}{q} ≪ {τ}_{R o F}$$

where p is pressure of the gas, pₒ is normal pressure, T is temperature of the gas, Tₒ=normal temperature, Kₒ is normalized ion mobility, m is mass, q is charge and τ_{RoF} is a time constant of the rotating confinement field which specifies how fast the rotating confinement field changes at a given point. The time constant of the rotating confinement field τ_{RoF} can be approximated by the time period T_{RoF}.

The trapped ion mobility separator may further be arranged such that

$${K}_{o} \frac{{p}_{o}}{p} \frac{T}{{T}_{o}} \frac{{U}_{R o F}}{{f}_{R o F}} \leq {c}_{R o F}$$

where c_{RoF} is a confinement constant, Kₒ is normalized ion mobility, p is pressure of the gas, pₒ is normal pressure, T is temperature of the gas, Tₒ is normal temperature, U_{RoF} is the potential difference between the maxima and minima of the electric potential rotating about the central axis and f_{RoF} is the angular frequency of the rotating confinement field.

In one embodiment of the invention, the pressure of the gas in the ion path of the trapped ion mobility separator can be higher than 5,000 Pa, more particularly higher than 10,000 Pa or 20,000 Pa and preferably equal to ambient pressure. The pressure of the gas in the ion path can be higher than the ambient pressure. The inner diameter of the radially-segmented electrodes is preferably less than 10 mm and more preferably at about 5 mm. The length of the ion path can be more than 30 mm, 50 mm, 100 mm or 200 mm.

In another embodiment of the invention, the trapped ion mobility separator may be combined with an ion trap that is located upstream of the trapped ion mobility separator and that also comprises a rotating confinement field-generating apparatus. The confinement field-generating apparatus of the ion trap also generates a radially-inhomogeneous electric potential that exerts a confinement force on the ions in a radial direction toward a central axis of the ion trap, with relative maxima and minima of said electric potential rotating about the central axis of the ion trap as a function of time. The ion trap is preferably operated at the same pressure as the downstream trapped ion mobility separator. The ion trap is preferably operated to accumulate ions from an ion source while the downstream trapped ion mobility separator analyzes ions which have been provided earlier from the ion source. The ion trap can be a second trapped ion mobility separator which is operated as an ion trap.

In another embodiment of the invention, an ion funnel may be located at the entrance and/or exit of a trapped ion mobility separator and may, itself, make use of a rotating confinement field-generating apparatus.

A trapped ion mobility separator according to the present invention can be combined with an ion source and an ion detector and can be operated as a stand-alone ion mobility spectrometer. The ion source of a stand-alone ion mobility spectrometer preferably generates ions by using spray ionization (e.g. electrospray (ESI) or thermal spray), desorption ionization (e.g. matrix-assisted laser/desorption ionization (MALDI) or secondary ionization), chemical ionization (CI), photo-ionization (PI), electron impact ionization (EI), or gas-discharge ionization. The ion detector is preferably a Faraday cup detector or an inductive detector. Two trapped ion mobility separators can further be combined wherein they are operated as a tandem ion mobility spectrometer. A tandem ion mobility spectrometer may comprise an activation and/or fragmentation cell between the two trapped ion separators and preferably an ion gate located between the upstream trapped ion mobility separator and the activation or fragmentation cell.

One or more trapped ion mobility separators according to the present invention may be used with other components as part of a hybrid system which couples ion mobility spectrometry and mass spectrometry. Such a hybrid system may comprise an upstream ion source, a trapped ion mobility separator and a downstream mass analyzer as ion detector. The ion source of the hybrid system can generate ions, for example, using spray ionization (e.g. electrospray (ESI) or thermal spray), desorption ionization (e.g. matrix-assisted laser/desorption ionization (MALDI) or secondary ionization), chemical ionization (CI), photo-ionization (PI), electron impact ionization (EI), or gas-discharge ionization. The mass analyzer of the hybrid systems can for example be one of a time-of-flight analyzer, an electrostatic ion trap, an RF ion trap, an ion cyclotron frequency ion trap and a quadrupole mass filter.

The trapped ion mobility separator of the hybrid system is preferably combined with an ion trap that is located upstream of the trapped ion mobility separator and that also comprises a rotating confinement field-generating apparatus. The ion trap is preferably operated at the same pressure as the trapped ion mobility separator. Furthermore, the ion trap is preferably operated to accumulate ions from an ion source while the trapped ion mobility separator analyzes ions which have been provided earlier from the ion source. The ion trap can be a second trapped ion mobility separator which is operated as ion trap.

The hybrid system can further comprise a fragmentation cell located between the trapped ion mobility separator and the mass analyzer. The ions can, for example, be fragmented in the fragmentation cell one of by collision induced dissociation (CID), surface induced dissociation (SID), photo-dissociation (PD), electron capture dissociation (ECD), electron transfer dissociation (ETD), collisional activation after electron transfer dissociation (ETcD), activation concurrent with electron transfer dissociation (Al-ETD) and fragmentation by reactions with highly excited or radical neutral particles. The hybrid system may further comprise a mass filter that is located between the trapped ion mobility separator and the fragmentation cell.

The hybrid system may comprise two trapped ion mobility separators between which an activation cell and/or a fragmentation cell are located. The two trapped ion mobility separators can be operated as a tandem ion mobility spectrometer inside the hybrid system. Preferably, an ion gate is located between the upstream trapped ion mobility separator and the activation or fragmentation cell.

The ion source and trapped ion mobility separator are preferably operated at a relatively high pressure, e.g. above 5,000 Pa, while the mass analyzer is operated in a vacuum. In one embodiment of the hybrid system, the ion source and the trapped ion mobility separator are both operated at ambient pressure, and a transfer device couples the trapped ion mobility separator to a downstream vacuum chamber of the hybrid system. The transfer device can, for example, comprise a single transfer capillary, multiple transfer capillaries, a multibore transfer capillary, a single aperture or multiple apertures. In another embodiment of the hybrid system, the hybrid system comprises two or more ion sources which are operated at different pressures wherein a first ion source operates at ambient pressure and a second ion source operates at sub-ambient pressure and wherein the trapped ion mobility separator is located in the chamber of the second ion source and operated at the sub-ambient pressure, e.g. in the range between 5,000 Pa and 50,000 Pa. The first ion source may be coupled to the chamber of the second ion source by one of the above transfer devices. The trapped ion mobility separator may be coupled to a downstream vacuum chamber by one of the above transfer devices or a pumping stage.

The hybrid system may further comprise a trapped ion mobility separator according to the prior art that is located between the trapped ion mobility separator according to the present invention and is operated at a pressure below 5,000 Pa and comprises a radio-frequency (RF) confinement field-generating apparatus for radially confining ions inside the trapped ion mobility separator.

In accordance with a second aspect of the present invention, ions are analyzed by using a trapped ion mobility separator comprising the steps: providing an ion path along which ions travel from an entrance to an exit of the separator along a first axial direction relative to a central axis of the ion path wherein the ion path contains a gas through which the ions pass; generating a first force that acts on the ions in the first axial direction; generating a second force that acts on the ions in a second axial direction opposite to the first axial direction, wherein at least one of the first and second forces varies spatially along the first axial direction such that ions are trapped and separated by ion mobility along said first axial direction; varying at least one of the first and second forces to increase a magnitude of the first force relative to the second force over time such that the ions are progressively driven to the exit of the ion path and separated as a function of ion mobility; and confining the ions using a rotating confinement field-generating apparatus that generates a radially-inhomogeneous electric potential that exerts a confinement force on the ions in a radial direction toward said central axis, wherein relative maxima and minima of the electric potential rotate about said central axis as a function of time.

The trapped ion mobility separator is preferably be operated such that

$${K}_{o} \frac{{p}_{o}}{p} \frac{T}{{T}_{o}} {f}_{R o F} \frac{m}{q} ≪ 1$$

where p is pressure of the gas, pₒ is normal pressure, T is temperature of the gas, Tₒ=normal temperature, f_{RoF} is the angular frequency of the rotating confinement field, Kₒ is normalized ion mobility, m is mass and q is charge.

The trapped ion mobility separator is preferably further operated such that

$${K}_{o} \frac{{p}_{o}}{p} \frac{T}{{T}_{o}} \frac{{U}_{R o F}}{{f}_{R o F}} \leq {c}_{R o F}$$

where c_{RoF} is a confinement constant, Kₒ is normalized ion mobility, p is pressure of the gas, pₒ is normal pressure, T is temperature of the gas, Tₒ is normal temperature, U_{RoF} is the potential difference between the maxima and minima of the electric potential rotating about the central axis and f_{RoF} is the angular frequency of the rotating confinement field.

The trapped ion mobility separator can be operated at a pressure higher than 5,000 Pa, more particularly at a pressure higher than 10,000 Pa or 20,000 Pa and preferably at ambient pressure. In certain embodiments, the ion mobility separator can be operated at a pressure higher than ambient pressure.

The ions to be analyzed can, for example, be generated by using spray ionization (e.g. electrospray (ESI) or thermal spray), desorption ionization (e.g. matrix-assisted laser/desorption ionization (MALDI) or secondary ionization), chemical ionization (CI), photo-ionization (PI), electron impact ionization (EI), or gas-discharge ionization.

The ions can be trapped in an ion trap located upstream of the trapped ion mobility separator. The ion trap is preferably operated to accumulate ions from the ion source while ions which have been provided earlier from the ion source are analyzed in the trapped ion mobility separator (parallel accumulation). The ions are preferably confined in the radial direction using a rotating confinement field-generating apparatus that generates a radially-inhomogeneous electric potential that exerts a confinement force on the ions in a radial direction toward the central axis of the ion trap, relative maxima and minima of said electric potential rotating about the central axis of the ion trap as a function of time. The ion trap can be a second trapped ion mobility separator which is operated as ion trap.

In a first embodiment, the separated ions are directly detected by an ion detector, e.g. by a Faraday cup detector or an inductive detector, in order to measure an ion mobility spectrum.

In a second embodiment, the separated ions are further analyzed as a function of mass in a mass analyzer located downstream of the trapped ion mobility separator in order to measure a combined mass-mobility map.

In a third embodiment, the separated ions are fragmented into fragment ions and the fragment ions are further analyzed as function of mass in a mass analyzer located downstream of the trapped ion mobility separator. The separated ions can further be filtered according to mass prior to the fragmentation, e.g. in a quadrupole mass filter, and/or can be selected prior to the fragmentation, e.g. in an ion gate.

In a fourth embodiment, ions of a specific ion mobility are selected, e.g. in an ion gate located adjacent to the trapped ion mobility separator. The selected ions are activated or fragmented in a downstream activation/fragmentation cell and further analyzed according to ion mobility, e.g. in an additional downstream trapped ion mobility separator.

### BRIEF DESCRIPTION OF THE DRAWINGS

FIG. 1A is a schematic depiction of a general version of a trapped ion mobility separator according to the present invention.

FIG. 1B shows the trapped ion mobility separator of FIG. 1A with the ions trapped and separated therewithin.

FIG. 1C shows the trapped ion mobility separator of FIG. 1A as the trapped ions are being eluted.

FIG. 2A is a schematic depiction of a trapped ion mobility separator according to the invention in which a constant velocity gas flow is opposed by an electric DC field gradient.

FIG. 2B is a schematic view of a series of rotationally-segmented electrodes used with the trapped ion mobility separator of FIG. 2A.

FIG. 2C is a graphical depiction of the gas flow velocity and the electric DC field gradient for the trapped ion mobility separator of FIG. 2A.

FIG. 2D is a graphical depiction similar to FIG. 2C, but which shows the effective velocity components of the electric DC field gradient for each of several ion species of different ion mobility.

FIG. 2E is a graphical depiction similar to FIG. 2D, but which shows the elution of the different ion species of different ion mobility.

FIG. 3A is a schematic depiction of a trapped ion mobility separator according to the invention in which a gradient velocity gas flow is opposed by a constant electric DC field.

FIG. 3B is a schematic view of a series of rotationally-segmented electrodes used with the trapped ion mobility separator of FIG. 3A.

FIG. 3C is a graphical depiction of the gas flow velocity and the electric DC field for the trapped ion mobility separator of FIG. 3A.

FIG. 3D is a graphical depiction similar to FIG. 3C, but which shows the effective velocity components of the electric DC field for each of several ion species of different ion mobility.

FIG. 3E is a graphical depiction similar to FIG. 3D, but which shows the elution of the different ion species of different ion mobility.

FIG. 4A is a schematic depiction of a trapped ion mobility separator according to the invention in which the axial component of a rotating confinement field is opposed by an electric DC field gradient.

FIG. 4B is a schematic view of a series of rotationally-segmented electrodes used with the trapped ion mobility separator of FIG. 4A.

FIG. 4C is a graphical depiction of the axial component of the rotating confinement field and the opposing electric DC field gradient for the trapped ion mobility separator of FIG. 4A.

FIG. 4D is a graphical depiction similar to FIG. 4C, but which shows the effective velocity components of the electric DC field gradient for each of several ion species of different ion mobility.

FIG. 4E is a graphical depiction similar to FIG. 4D, but which shows the elution of the different ion species of different ion mobility.

FIG. 5A is a schematic depiction of a trapped ion mobility separator according to the invention in which a gradient velocity gas flow is opposed by the axial component of a rotating confinement field.

FIG. 5B is a schematic view of a series of rotationally-segmented electrodes used with the trapped ion mobility separator of FIG. 5A.

FIG. 5C is a graphical depiction of the gas flow velocity and the axial component of the rotating confinement field for the trapped ion mobility separator of FIG. 5A.

FIG. 5D is a graphical depiction similar to FIG. 5C, but which shows the effective velocity components of the axial component of the rotating confinement field for each of several ion species of different ion mobility.

FIG. 5E is a graphical depiction similar to FIG. 5D, but which shows the elution of the different ion species of different ion mobility.

FIG. 6A is a schematic depiction of a trapped ion mobility spectrometry system that uses a trapped ion mobility separator according to the invention together with an ion source and an ion detector.

FIG. 6B is a schematic depiction of a trapped ion mobility spectrometry system that uses a trapped ion mobility separator according to the invention, together with an ion source, an ion trap and an ion detector.

FIG. 7A is a schematic depiction of a hybrid system that uses a trapped ion mobility separator according to the invention at atmospheric pressure, together with an ion source, an ion funnel, a mass filter, a fragmentation cell and a mass analyzer as ion detector.

FIG. 7B is a schematic depiction of hybrid system similar to that of FIG. 7A, but that uses the trapped ion mobility separator according to the invention in combination with an upstream ion trap and a downstream ion funnel, both with a rotating confinement field.

FIG. 7C is a schematic depiction of a hybrid system similar to that of FIG. 7A, but that uses the trapped mobility separator according to the invention in combination with an upstream ion trap and a downstream ion gate, and a low-pressure trapped ion mobility separator with a radio-frequency confinement field.

FIG. 7D is a schematic depiction of a hybrid system similar to that of FIG. 7C, but which uses a downstream activation/fragmentation cell before the low-pressure trapped ion mobility separator with a radio-frequency confinement field.

FIG. 7E is a schematic depiction of a hybrid system similar to that of FIG. 7B, but which uses both low-pressure and high-pressure ion sources.

### DETAILED DESCRIPTION

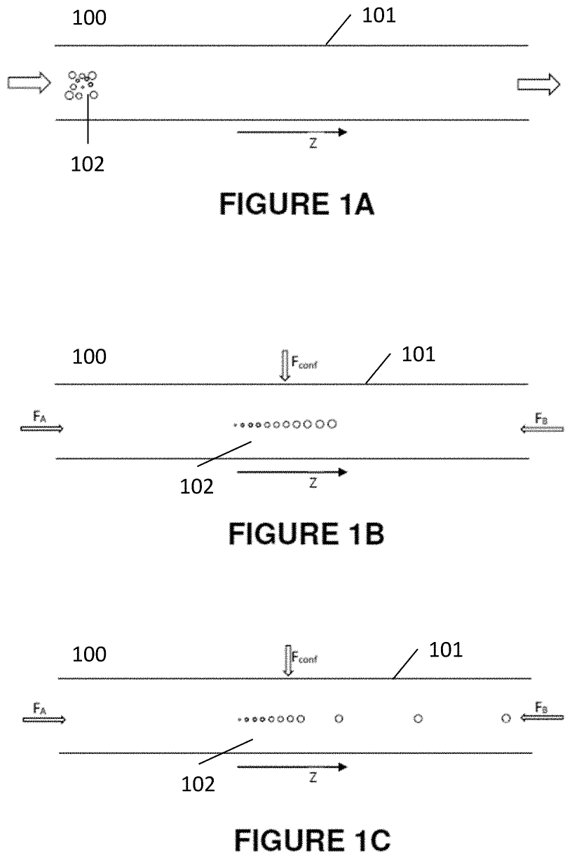

FIGS. 1A-1C show schematically three stages of operation for a general version of a trapped ion mobility separator 100 according the invention. The trapped ion mobility separator 100 includes an ion channel 101, which typically includes a structure that surrounds the ion path and includes electrodes for generating electric fields within the ion channel 101. As shown in FIG. 1A, ions 102 enter from one side of the channel 101, and will eventually travel to the opposite side of the channel, being temporarily trapped along the way at mobility dependent positions. The ions 102 are the molecular constituents of a sample material of interest, which have been ionized and introduced to the ion channel, typically from an ionization source of a known type, such as an electrospray or MALDI (matrix-assisted laser desorption ionization) type ion source or CI (chemical ionization) ion source. The ions 102 enter the channel 101 having arbitrary position and velocity, but will be separated by ion mobility prior to leaving the channel. From there, they may be directed to an ion detector (for example, as part of an ion mobility spectrometer), or to another analysis system that makes use of the separated ions (for example, a mass analyzer).

The direction of travel of the ions 102 along the ion channel 101 is defined as the z-direction, and is indicated by the arrows in FIGS. 1A-1C. Separation of the ions 102 by ion mobility is done with the use of opposing forces FA and FB in an axial direction relative to the ion channel 101, which produce counteracting velocity components at least one of which depends on ion mobility, and which thereby effects a mobility dependent separation. One of the opposing forces may be generated by a gas flow along the z-axis, either in the same direction as the ion travel, or in an opposite direction. It is also possible that the counteracting force is generated by an electric DC field, acting on the ions in the presence of a residual gas.

At least one of the opposing forces FA and FB also varies spatially along at least a portion of the z-axis. The opposing forces FA and FB are preferably balanced such that, for each species of ion of interest in the group of ions 102, an equilibrium point of zero velocity exists within the ion channel 101. Since a mobility-dependent force has a different influence on ions of different mobility, the spatial position along the z-axis for which the net velocity of an ion is zero will depend on the mobility K of that ion. Thus, as shown schematically in FIG. 1B, the ions are trapped along the axis at mobility dependent positions under the influence of the opposing axial forces FA and FB. In the figure, the ions are shown as circles, with circles of larger diameter representing ions of larger cross-section and thus of lower mobility K. Those skilled in the art will understand, however, that the ions 102 could also be separated along the z-axis from higher to lower mobility, depending on the relative arrangement of the opposing axial forces.

The trapped ions 102 are eventually eluted from the ion channel 101 by changing one or both of the forces FA and FB such that the velocity components change and the equilibrium point for an ion species to be eluted is not within the ion channel 101. This relative change in the opposing axial forces may be progressive, such that ion species of increasing or decreasing mobility K successively exit the trapped ion mobility separator 100 in the z-direction. In FIG. 1C, for example, the ions 102 are eluted from the trapped ion mobility separator 100 in from lower to higher mobility K.

In addition to the opposing axial forces FA and FB, the invention also makes use of a radial confinement force F_{CONF}, which urges the ions toward the central axis of the ion channel 101. This force is indicated in FIGS. 1B and 1C by the radially-directed arrow labeled F_{CONF}. Because the influence of certain opposing axial forces on the ions 102, particularly at higher pressures, can cause the ions to be directed away from the central axis of the ion channel 101, the radial confinement force F_{CONF} redirects the ions toward the central axis, and prevents them from escaping the ion channel 101 or being destroyed in a collision with an electrode or other structural element of the ion channel 101. In particular, the radial confinement force allows for effective ion mobility separation, even at atmospheric pressure. The radial confinement can also be beneficial in that the separating power may be higher on the central axis as compared to off-axis positions.

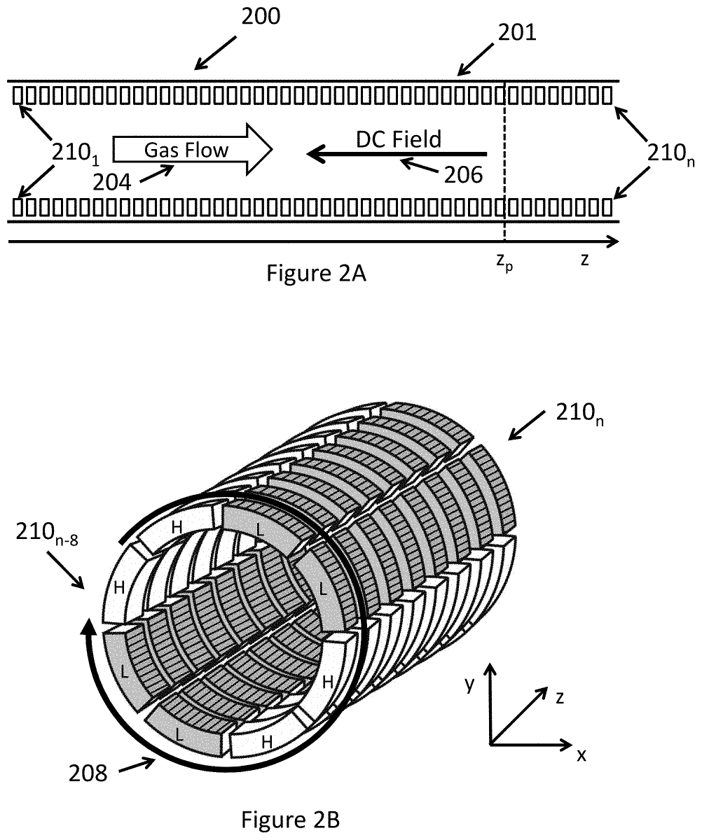

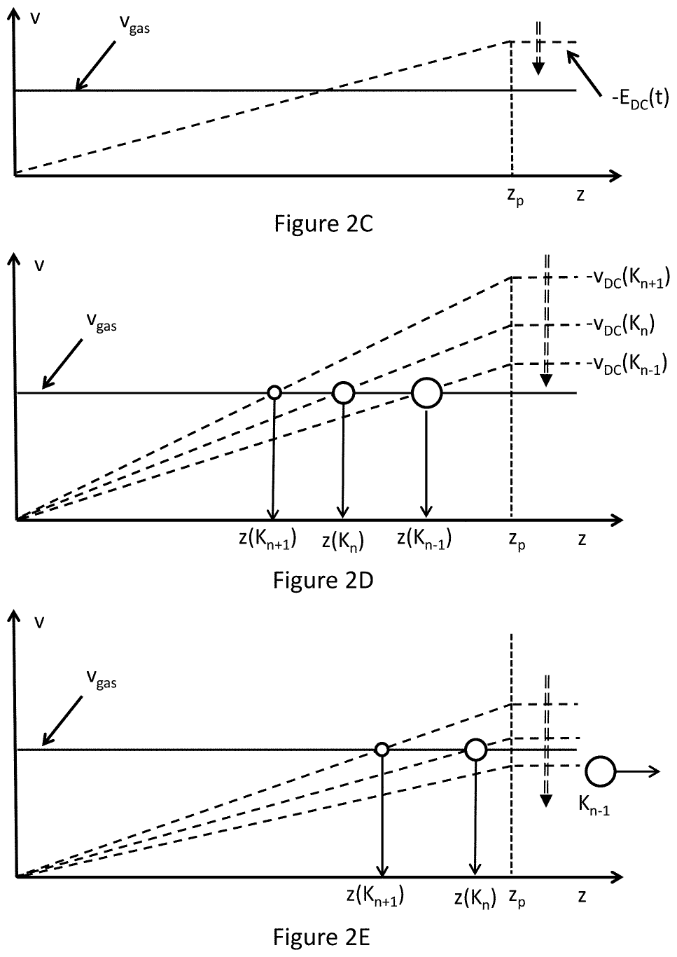

A first embodiment of the invention is shown in FIGS. 2A-2E. The schematic view of FIG. 2A shows an outer housing 201 of trapped ion mobility separator 200, which is operated at a nominal pressure of 20,000 Pa (200 mbar). As in FIGS. 1A-1C, ions enter the trapped ion mobility separator 200 at the left side relative to the orientation of the figure, traveling in the direction of the z-axis. The ions are subjected to opposing axial forces within the trapped ion mobility separator 200, generated by a gas flow 204 in the positive direction of the z-axis and an electric DC field 206 in the negative direction of the z-axis. The gas flow may have a velocity up to 20 m/s. In this embodiment, the trapped ion mobility separator 200 has a cylindrical shape, and along an inner surface of the housing 201 is a series of radially-segmented electrodes 210, each of which comprises electrode segments equally spaced along the inner circumference of the housing 201. These segmented electrodes are used to provide a rotating confinement field that prevents excessive deviation of the ions from a longitudinal axis of the trapped ion mobility separator 200.

A schematic, perspective view of the segmented electrodes 210 is shown in FIG. 2B. In this embodiment, each electrode has eight radial segments, and DC voltages may be individually applied to each of the electrode segments. To provide the desired rotating field, the electrode segments of each electrode are energized (a high electrical potential state) and deenergized (a low electrical potential state) according to a predetermined protocol, which simulates a rotation of the electrical potentials about the electrode. In this embodiment, the rotational direction of the energizing is shown in the figure by arrow 208, with the energized/deenergized state of all of the electrode segments being updated simultaneously with a regular periodicity. To provide a “rotation” of the electrical potentials, each time the electrical potential states of the electrode segments are updated, each segment assumes the last state of the electrode segment adjacent to it in the rotational direction opposite the direction of the arrow. In this way, the electrical potentials “rotate” about the electrode in the direction of the arrow 208.

FIG. 2B shows the electrical potential states of the electrode segments at a given moment in time, with energized segments being unshaded and labeled (on the outermost electrode) by the letter “H.” The deenergized segments in the figure are shown as shaded, and labeled (on the outermost electrode) by the letter “L.” From the shading it can be seen that, in this embodiment, the rotational position of the energized and deenergized segments is the same for each of the electrodes along the longitudinal direction of the trapped ion mobility separator 200. Thus, the radial confinement forces provided by the electric fields generated by the electrical potentials applied to the segmented electrodes are radially aligned at any particular moment in time.

The segmented electrodes 210 are shown in schematic cross section in FIG. 2A, and are labeled along the longitudinal direction of the trapped ion mobility separator 200 from segment 210₁ to 210ₙ. Those skilled in the art will understand that the actual number of segmented electrodes used may vary depending on the application. In this embodiment, the ion channel has a length of 50 mm, and the electrodes have an inner diameter of 5 mm. As shown in FIG. 2B, the rotating field is symmetric about the central axis. There is an axial symmetrical distribution of energized and deenergized segments about the electrode at any given point in time. The pattern in this embodiment, using the designations of “H” for an energized segment and “L” for a deenergized segment, is therefore HHLLHHLL, with that potential distribution rotating continuously about each electrode. In this embodiment, the high potential “H” is 450 V, while the low potential “L” is 0 V, and the rotation frequency is 125 KHz.

The electrical potentials applied to the segmented electrodes provide a “rotating field” confinement force on the ions that urges them toward a central longitudinal axis of the trapped ion mobility separator 200. Because the ions can be deviated in a radial direction during the separation process, particularly at elevated pressures, the use of the confinement field prevents ion loss that might otherwise occur if the ions were to make contact with electrodes 210 or the housing 201 of the trapped ion mobility separator 200. Rotation of the confinement field at a sufficient frequency provides a time-averaged force on the ions that is in a radially-inward direction. Thus, the ions remain near the center of the trapped ion mobility separator 200 while being separated by the opposing axial forces to which they are subjected.

The effect of the opposing axial forces on the ions in the trapped ion mobility separator 200 is shown in FIGS. 2C-2E, each of which is a graph of velocity (or an effective velocity component) versus position along the z-axis. As shown in FIG. 2C, there is a constant gas velocity, v_{gas}, pushing the ions through along the z-axis. Opposing this motion, is a electric DC field −E_{DC}(t) that has a spatial gradient along the z-axis, increasing from zero to a maximum at longitudinal position zₚ which, as discussed below, may be an elution point for ions at which the ions are not trapped anymore in the trapped ion mobility separator 200. The negative value of the electric DC field is due to its directional opposition to the longitudinal force of the gas, and it is represented as a function of time because, in this embodiment, the strength of the electric DC field is lowered during elution of the different ion species.

FIG. 2D is similar to FIG. 2C, but depicts the “effective” velocity component −v_{DC} due to the counteracting electric DC field for each of several different ion species, Kₙ₋₁, Kₙ and Kₙ₊₁. This “effective” velocity component is mobility dependent in the presence of a gas, and the corresponding −v_{DC} gradient is therefore shown in the figure in broken lines for each of the ion species Kₙ₋₁, Kₙ and Kₙ₊₁. These gradients represent the velocity components that would be imparted to the different ion species by the electric DC field E_{DC}(t) in the absence of the gas flow v_{gas}. That is, −v_{DC} represents the velocity component attributable to the electric DC field for an ion in a resting gas at a given pressure and temperature. This value is proportional to the strength of the electric DC field, and different for each ion species having a different mobility K (where v_{DC}=K·E_{DC}). The “effective” velocity provided by the gas flow in the absence of the electric DC field is v_{gas} for all ion species Kₙ₋₁, Kₙ and Kₙ₊₁.

The electric DC field gradient along the z-axis results in a corresponding gradient for −v_{DC} that is different for ion species of different mobility, as shown in FIG. 2D. During an initial accumulation phase for the ions, the magnitude of the electric DC field is such that, for each of the ion species of interest, −v_{DC} is equal and opposite to the velocity component v_{gas} imparted by the gas flow at a different position along the z-axis. Because of the different −v_{DC} gradients of the different ion species, the ions of the different species will be separated from one another, and trapped at different respective positions along the z-axis. The different ion species, Kₙ₋₁, Kₙ and Kₙ₊₁, are represented in FIG. 2D by circles of different sizes, the larger circles corresponding to ion species of larger cross-section and thus of lower mobility K.

Following separation of the different ion species, the ions may be sequentially eluted from the trapped ion mobility separator 200, and directed to a downstream component or to an ion detector. The elution is done by gradually reducing the magnitude of the electric DC field gradient, which correspondingly reduces the magnitudes of the −v_{DC} velocity component gradients, as shown in FIG. 2E. As these gradients are reduced, the point at which the counteracting velocity components v_{gas} and −v_{DC} cancel each other is shifted in the +z direction for each of the different ion species, toward the exit of the trapped ion mobility separator 200. The structure of the electric field is such that the gradient increases in the +z direction until it reaches a plateau at the elution point zₚ along the z-axis. Since the ion trapping position is different for each of the different ion species, the shifting of these trapping positions by lowering of the electric DC field gradient results in each ion species arriving at the elution point zₚ at a different time. Upon arrival at the elution point, an ion species is no longer trapped by the counteracting velocity components, and exits the trapped ion mobility separator 200 in the +z direction, as shown for ion species Kₙ₋₁ in FIG. 2E. In this way, the separated ion species are eluted from the trapped ion mobility separator 200 in a sequential manner, from low mobility to high mobility.

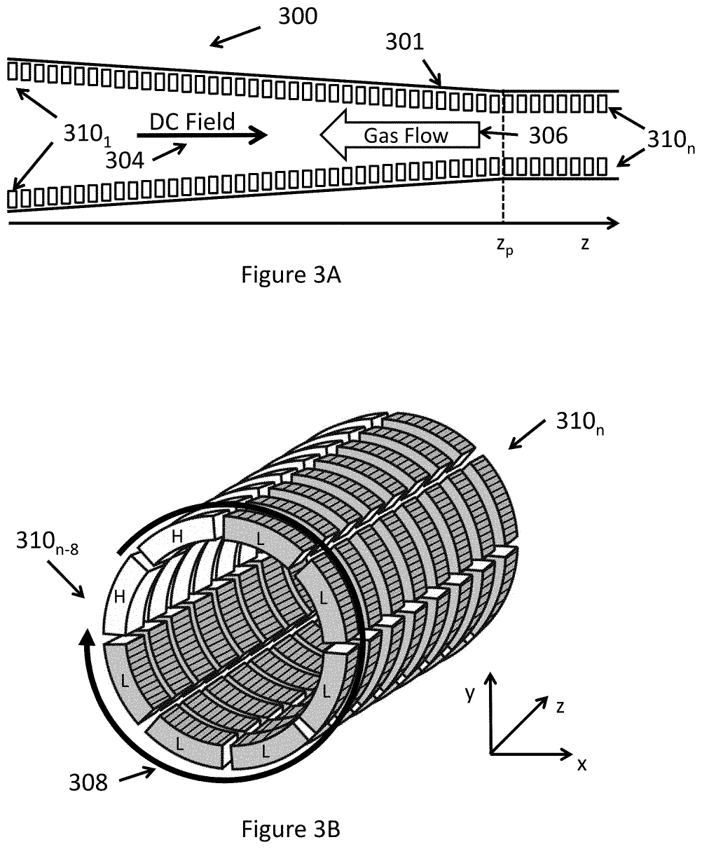

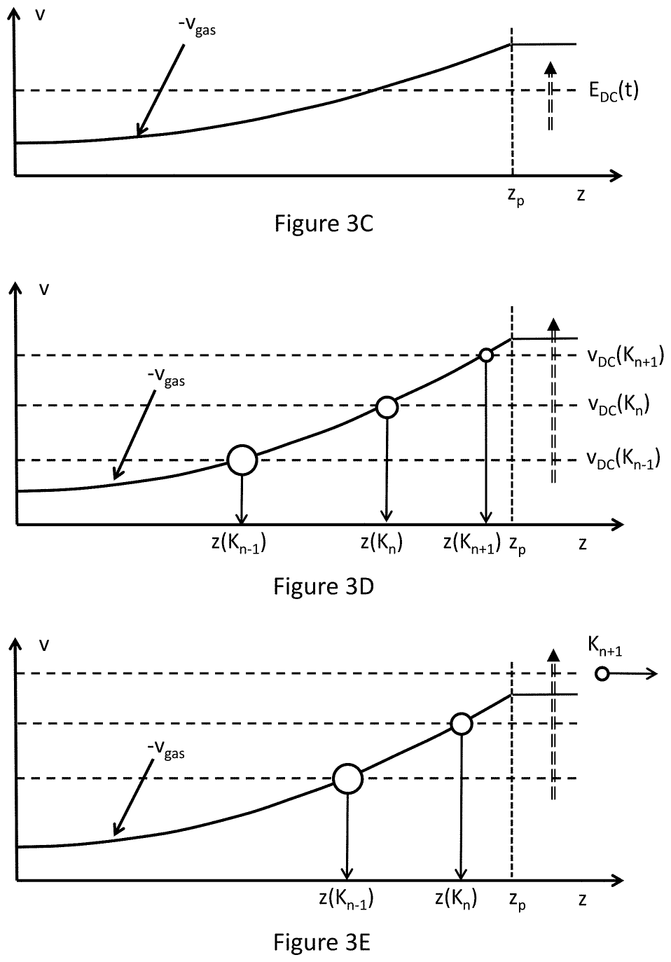

An alternative embodiment of the invention is shown in FIGS. 3A-3E. In this embodiment, a spatially constant electric DC field 304 is used to provide a velocity component to the ions in trapped ion mobility separator 300 in the +z direction. A counteracting gas flow 306 provides a gradient velocity component in the −z direction. The spatially-varying effect of the gas flow is created by using a housing 301 with a varying diameter that narrows in the +z direction (and therefore widens in the direction of the gas flow). Due to this changing diameter, the velocity of the gas flow decreases from the elution point zₚ to the point of ion entry into the trapped ion mobility separator 300. This spatial variation in the gas flow velocity is shown graphically in FIG. 3C, and is labeled −v_{gas}, since the gas flow is in opposite direction of the ion path. The electric DC field does not vary spatially along the z-axis, and it is shown in the figure by a broken line labeled E_{DC}(t). This has the advantage that the electric DC field does not contribute to a radially defocusing of the ions.

Also shown in FIG. 3A are a series of segmented electrodes 310. These electrodes are similar to those of FIGS. 2A and 2B, and they are used to generate a rotating electric field in a similar way. Since the housing 301 of the trapped ion mobility separator 300 has a varying diameter, and the segmented electrodes 310 are positioned along the inner circumference of the housing, the segmented electrodes 310 also have a circumference that changes along the length of the trapped ion mobility separator. However, since the segmented electrodes 310 are centered about the z-axis, and the relative positions of the electrode segments are rotationally symmetric, the electrodes provide the desired confinement force along the entire length of the ion channel that urges the ions toward the longitudinal axis of the trapped ion mobility separator 300.

As shown in the schematic perspective view of FIG. 3B, the segmented electrodes 310 used in this embodiment each consist of eight electrode segments that are equally spaced about the electrode circumference. To provide the desired rotating field, the electrode segments of each electrode 310 are energized and deenergized to simulate a rotation of the electrical potentials about the electrode in the direction of arrow 308. The manner of energizing and deenergizing the electrode segments is the same in this embodiment as in the embodiment of FIG. 2B, but the electrical potentials applied to the segments in FIG. 3B is different. In particular, the instantaneous state of the electrical potentials of the segments relative to one another is not symmetric about the central axis but, rather, involves two adjacent segments being energized simultaneously, while the other segments are deenergized. The progression of the electrical potentials follows the direction of the arrow 308, such that the two energized segments advance together one segment at a time about the electrode. The energized segments are shown unshaded with the label “H,” while the deenergized segments are shown shaded with the label “L.” Thus, it can be seen that the rotating field is asymmetric to the central axis and the electrical potential pattern in this embodiment is HHLLLLLL, with that distribution rotating continuously about each electrode.

In this embodiment, the length of the trapped ion mobility separator 300 is approximately 100 mm, with the segmented electrodes 310 having a diameter that decreases to 5 mm at the elution point zₚ. The trapped ion mobility separator 300 is operated at a pressure of approximately 100,000 Pa (1000 mbar), and the high potential “H” is 400 V, while the low potential “L” is 0 V. The rotation frequency of the electrode segment potentials is 25 KHz and, as shown in FIG. 2B, the position of the energized segments is the same for all of the electrodes at any given time, such that the rotating field is synchronized all along the length of the trapped ion mobility separator 300. The gas velocity may vary between 6 m/s to 20 m/s in the gradient, alternatively between 5 m/s and 10 m/s at a reduced mobility range.

As shown in FIG. 3D, the magnitude of the velocity component −v_{gas} due to the gas flow is a gradient along the z-axis, while the velocity component v_{DC} is spatially constant, albeit at a different magnitude for different ion species. The figure shows how, during an initial accumulation phase, the velocity components are balanced such that the different ion species are separated along the z-axis, but remain trapped within the trapped ion mobility separator 300. Because the ion species of higher mobility have a stronger “effective” velocity component v_{DC} in opposition to the counteracting gas velocity gradient than those ion species of lower mobility, the higher mobility species Kₙ₋₁ is shown closer to the exit of the trapped ion mobility separator 300 than lower mobility species Kₙ₊₁. For elution of the ions, the magnitude of the electric DC field is increased gradually with time, resulting in a shifting of the trapped ions toward the elution point zₚ. When the electric field strength is high enough, high mobility ion species Kₙ₊₁ is eluted, as shown in FIG. 3E, followed by the other ion species in order of decreasing ion mobility.

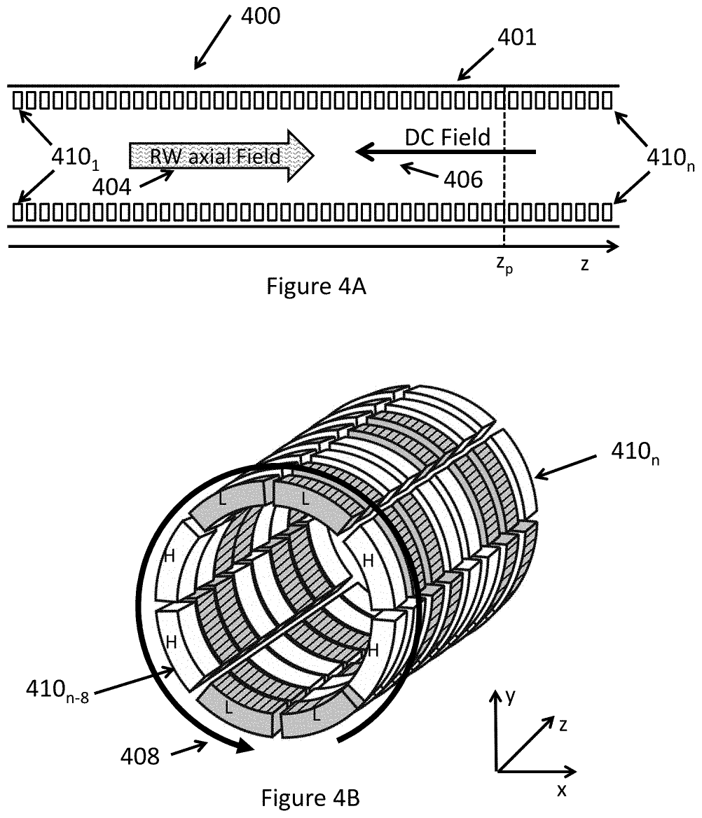

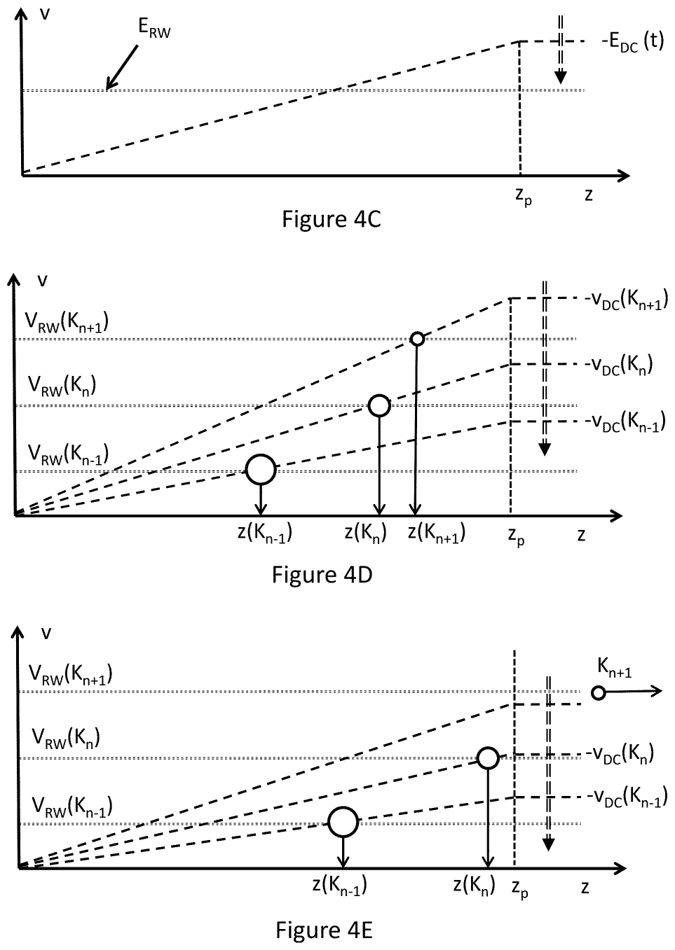

The embodiment of FIGS. 4A-4E differs from the aforementioned embodiments in that no gas flow is used to provide mobility separation of the ion species. As shown in FIG. 4A, an electric DC field gradient 406 opposes the travel direction of the ions in trapped ion mobility separator 400, while the counteracting force is provided by an axial component of a rotating electric field 404 generated using segmented electrodes 410. The electric DC field gradient in this embodiment is of the same type as described in the embodiment of FIGS. 2A-2E, varying in magnitude from zero near an entrance of the trapped ion mobility separator 400 to a maximum at elution point zₚ. A resting gas is maintained in the trapped ion mobility separator 400 at a pressure of 100,000 Pa (1000 mbar), and the velocity component in the −z direction provided by the electric DC field gradient is therefore different for each ion species. The opposing velocity component in the +z direction is provided by an axial force component of the rotating field generated by the segmented electrodes, as discussed in more detail below.

FIG. 4B is a schematic perspective view of a sequence of eight segmented electrodes that might reside along a portion of the trapped ion mobility separator 400. As in earlier drawings, each electrode consists of eight segments and, in the figure, the energized segments are unshaded and labeled “H”, while the deenergized segments are shaded and labeled “L.” The energizing of the segments of any given electrode is symmetric, using an HHLLHHLL pattern but, unlike the embodiment of FIG. 2B, the rotational position of the energized and deenergized segments is not synchronized from one electrode to another. Rather, while the rotation of the electrical potentials in the direction of arrow 408 is at the same frequency for all of the electrodes, the rotational positions of the energized and deenergized segments are offset from one electrode to the next, so as to create axial electric field components between them.

In FIG. 4B, the rotational position of the energized segments of an electrode at any point in time is offset by one relative to an adjacent electrode. As can be seen by the shading of the segments, in the +z direction, each sequential electrode has a rotational position that is advanced one step relative to the immediately preceding electrode. As the rotation of the electrical potentials is at the same frequency for each of the electrodes, this relative offset of rotational positions from one electrode to the next remains intact during the rotation. However, the rotation of the electrical potentials with this progressive offset produces an axial field component in the +z direction and, therefore, a velocity component that opposes the velocity component resulting from the electric DC field gradient and that depends on ion mobility.

The counteracting electric field components are shown in FIG. 4C. Since the effect of the electric DC field gradient on the ions is mobility dependent, the velocity component gradients are different for the different ion species Kₙ₋₁, Kₙ and Kₙ₊₁, as shown in FIG. 4D. Moreover, because the axial velocity component v_{RW} generated by the rotating potentials on the segmented electrodes will also be mobility dependent, the different magnitudes of these components are also shown for the different ion species. During an ion accumulation phase, the opposing forces are balanced so that the ions are trapped with ion species of different ion mobilities K at different axial positions within the trapped ion mobility separator 400. Because higher mobility ion species are less influenced by the presence of the resting gas in the trapped ion mobility separator 400, the equilibrium point between the counteracting forces for those ion species is closer to the elution point zₚ, while the ion species of lower mobility will be trapped closer to the entrance of the trapped ion mobility separator 400.

The trapped ion mobility separator in this embodiment is operated at a pressure of approximately 100,000 Pa (1000 mbar) and has a length of 100 mm and an inner diameter of 5 mm. A symmetric potential pattern HHLLHHLL is used with a potential of 400V on the energized segments, and a potential of 0V on the deenergized segments, the rotation frequency being 30 KHz. Elution of the ions in this embodiment is done by gradually reducing the magnitude of the electric DC field. This will result in the sequential elution of the ion species from higher mobility to lower mobility. As shown in FIG. 4E, relatively low ion mobility species Kₙ₊₁ exits the trapped ion mobility separator 400, while the higher mobility ions remain trapped. Eventually, all of the ions are eluted, and are transferred to a downstream component or to a detector.

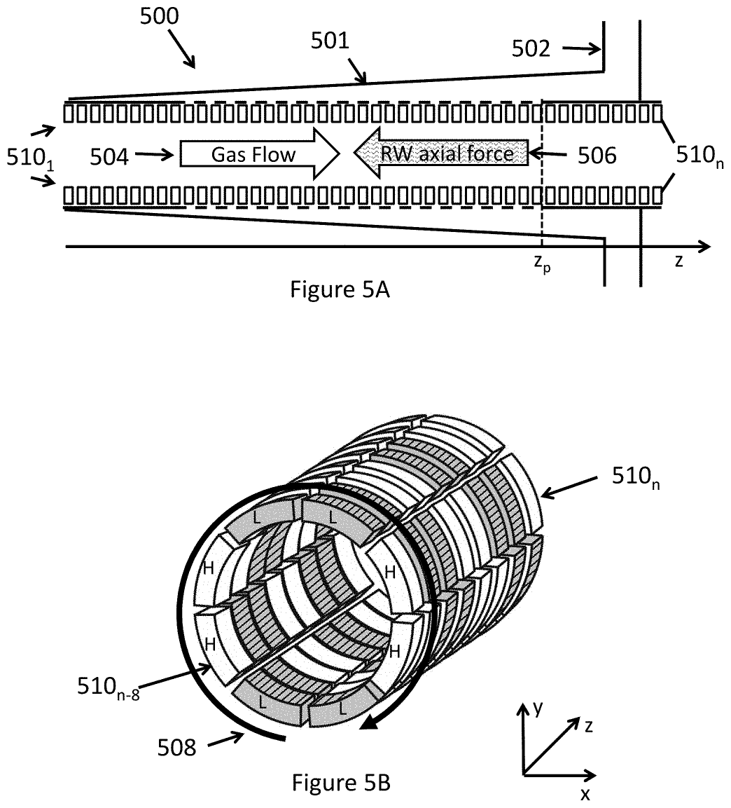

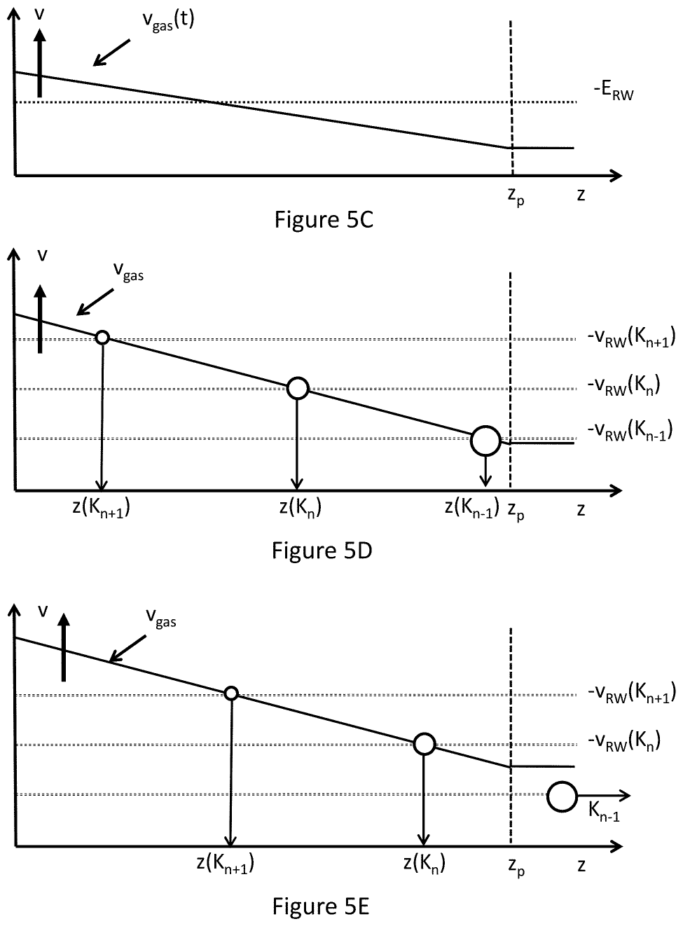

The embodiment of FIGS. 5A-5E makes use of a gas flow 504 having a velocity that decreases in the +z direction, which is opposed by the axial component 506 of a rotating field generated using segmented electrodes 510. The velocity gradient is generated within the trapped ion mobility separator 500 of constant inner diameter by pumping away the gas with varying pumping speed in the +z direction. As gas is pumped away through one or more pumping ports 502, gas within the trapped ion mobility separator 400 passes through gaps 507 located between the electrodes 510. The velocity component within the trapped ion mobility separator 500 decreases along the z-axis until reaching the elution point zₚ, after which no gas is pumped away in a radial direction, resulting in a plateau in the gradient. As shown in FIG. 5B, the offset of the rotational positions of the energized and deenergized segments from one electrode to the next is the same as in the embodiment of FIG. 4B.

The counteracting forces of this embodiment are represented in FIG. 5C, which shows the spatial gradient of the gas velocity in the +z direction, and the magnitude of the axial component −E_{RW} of the rotating field that opposes it. Since the velocity components generated by the axial component of the rotating field are ion mobility dependent, the different ion species will be separated by mobility along the z-axis during a trapping phase, as shown in FIG. 5D. In order to elute the ions, the velocity of the gas flow is increased gradually such that each ion species arrives sequentially at the elution point zₚ and exits the trapped ion mobility separator 500, as is shown in FIG. 5E for the ion species having a mobility Kₙ₋₁. The trapped ion mobility separator in this embodiment is operated at a pressure of approximately 100,000 Pa (1000 mbar) and has a length of 60 mm and an inner diameter of 5 mm. A symmetric electrical potential pattern HHLLHHLL is used with a potential of 450V on the energized segments, and a potential of 0V on the deenergized segments, the rotation frequency being 25 KHz. Prior to elution, the gas velocity gradient is 2 m/s at the entrance of the trapped ion mobility separator 500 and 0.5 m/s at the elution point. During elution, this gradient is increased over time to 8 m/s at the entrance of the trapped ion mobility separator 500 and 2 m/s at the elution point.

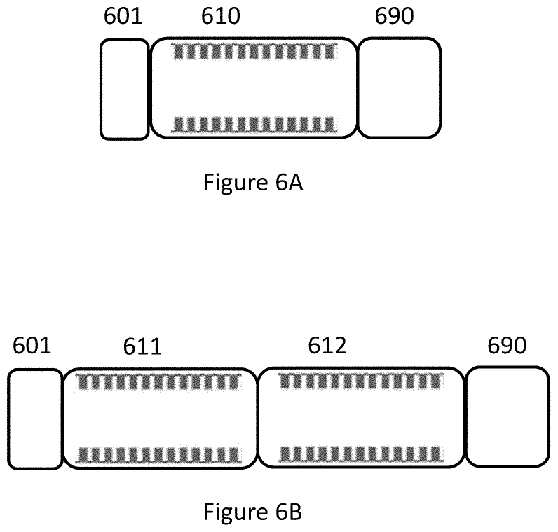

FIG. 6A shows schematically an ion mobility spectrometry system that may make use of channel trapped ion mobility separator according to the present invention. In this embodiment, an ion source 601 is operated at atmospheric pressure, and may be any of a number of known ion source types, such as photoionization, chemical ionization, or dielectric barrier discharge ionization (DBDI). The ions generated by ion source 601 are introduced to channel trapped ion mobility separator 610 like one of those described above, which has a rotating field confinement system.

In the manner described above, ions collected in the trapped ion mobility separator 610 are trapped, separated and eluted in order of either decreasing or increasing ion mobility. The exiting ion species are detected sequentially by ion detector 690, which records the intensity of the ion signal for each ion species, thereby allowing the construction of an ion mobility spectrum corresponding to the constituent components of the ions input from the ion source 601. The ion detector 690 is preferably a Faraday cup detector. An IMS instrument of this type may be particularly useful for measurement of pollutants in air, such as for monitoring chemical laboratories, monitoring filters, controlling drying processes, monitoring waste air, or for detecting chemical warfare agents, explosives or drugs.

FIG. 6B shows schematically an IMS system using a different arrangement of components. In this embodiment, ion source 601 is a known ion source that operates at a pressure higher than atmospheric pressure, such as a chemical ionization source or DBDI source. Ions generated by the ion source 601 enter an ion trap 611 in which the ions are radially confined by a rotating electric field, and axially confined by counteracting axial electric DC fields. The ion trap can be a trapped ion mobility separator device like that of the present invention such that the ion species are trapped at different axial positions depending on ion mobility, before being sequentially transferred to a trapped ion mobility separator 612 according to the present invention.

Once the separated ions are received by the trapped ion mobility separator 612, they are separated and eluted sequentially by ion mobility and detected by ion detector 690. During the process of separating and eluting the ions by the trapped ion mobility separator 612, a new group of ions is transferred from ion source 601 to the ion trap 611, before being subsequently transferred to the trapped ion mobility separator 612 once the previous group of ions has been fully scanned out. Each of the ion trap 611 and the trapped ion mobility separator 612 uses a rotating confinement field like those described herein in order to preserve the radial confinement of the ions.

The embodiment of FIG. 6B has the advantage of collecting the ions in an initial step using the ion trap 611, while a previous group of ions is being eluted out of the trapped ion mobility separator 612 and detected by ion detector 690. In an exemplary version of this embodiment, the ion detector 690 is a Faraday cup detector, and the device is used for the same types of applications as the embodiment of FIG. 6A.

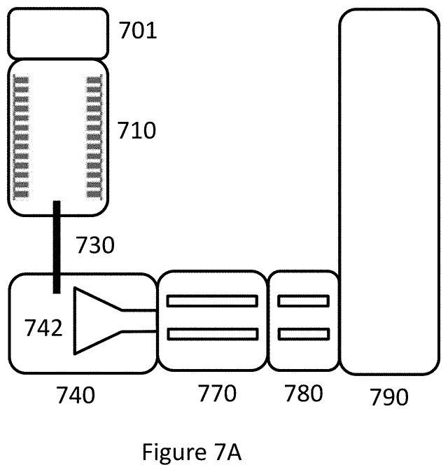

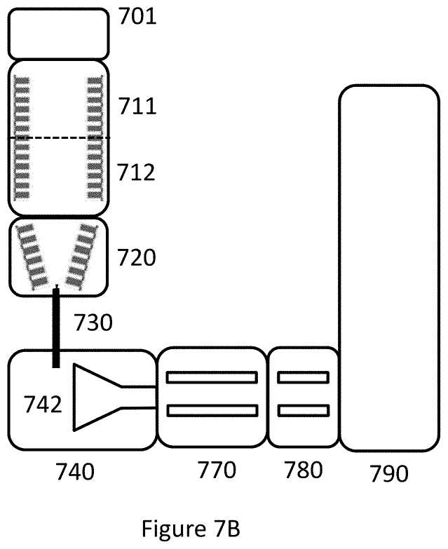

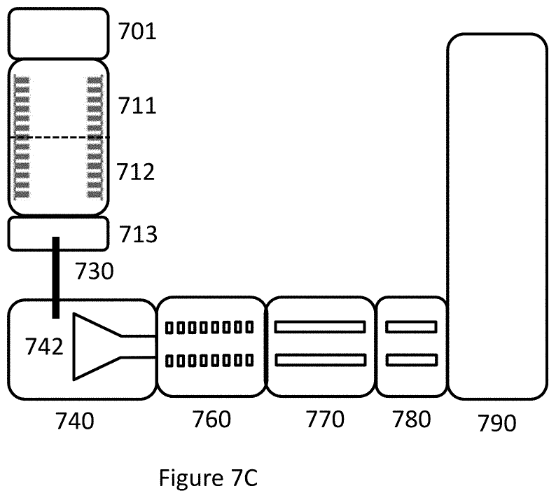

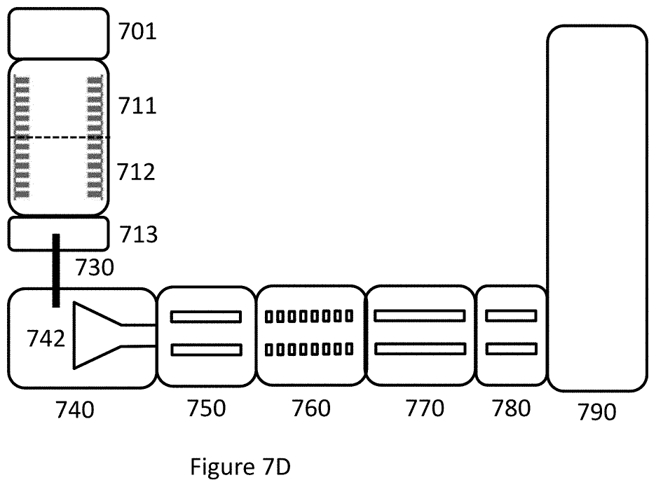

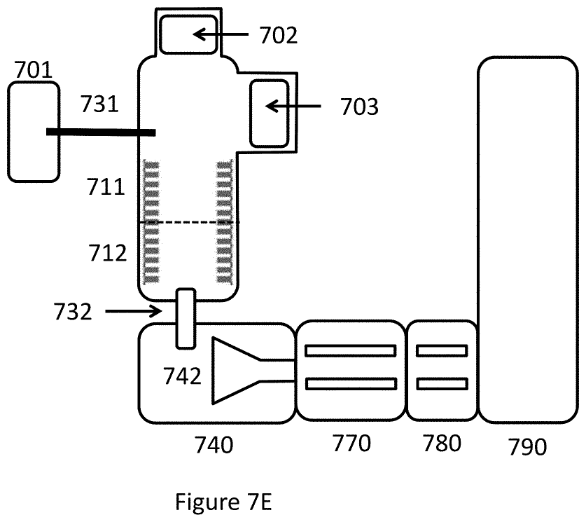

FIG. 7A shows a hybrid system embodiment that couples ion mobility (IMS) and mass spectrometry (MS) and that makes use of a trapped ion mobility separator device according to the invention. An ion source 701 is operated at atmospheric pressure and, in the exemplary embodiment, is an electrospray ion source. Other possible ion source types include thermal spray, desorption ionization (e.g. matrix-assisted laser/desorption ionization (MALDI) or secondary ionization), chemical ionization (CI), photo-ionization (PI), electron impact ionization (EI), and gas-discharge ionization. The ions output from ion source 701 are introduced to a trapped ion mobility separator 710, which is an ion mobility separation device like one of those shown herein.

The trapped ion mobility separator 710 is operated at atmospheric pressure and outputs ions that have been separated by ion mobility, which are then transferred via transfer device 730 to a first vacuum chamber 740 of the ion mobility spectrometry/mass spectrometry (IMS-MS) hybrid system. The transfer device 730 may be any one of a number of different ion transfer components, such as a single transfer capillary, multiple transfer capillaries a multi-bore transfer capillary, a single aperture or multiple apertures. Upon arriving in the first vacuum chamber 740, the ions are deflected into an ion funnel 742, in a manner such as that shown and described in co-pending U.S. patent application Ser. No. 16/884,626.

Within the evacuated portion of the hybrid IMS-MS system, the separated ions are transferred from the first vacuum chamber 740 to mass filter 770. The mass filter 770 is of a known type, such as a quadrupole mass filter, that limits ion transmission to only those ions within a specific range of mass-to-charge ratios m/z. The ions that pass through the mass filter are then directed to a fragmentation cell 780, in which larger ions are fragmented to allow mass spectrometric measurement of the ion fragments. In the exemplary embodiment, fragmentation is done using infrared multiple photon-dissociation (IRMPD) or ultraviolet photo-dissociation (UVPD), as is known in the art. However, any number of other known types of fragmentation may also be used including, but not limited to, collision induced dissociation (CID), surface induced dissociation (SID), photo-dissociation (PD), electron capture dissociation (ECD), electron transfer dissociation (ETD), collisional activation after electron transfer dissociation (ETcD), activation concurrent with electron transfer dissociation (Al-ETD) and fragmentation by reactions with highly excited or radical neutral particles.

After fragmentation, the fragmented ions are directed to mass analyzer 790, which may be any of as number of different types of mass analyzers. In the present embodiment, the mass analyzer is a time-of-flight mass analyzer with orthogonal ion injection, as is known in the art. Other possible mass analyzers include an electrostatic ion trap, an RF ion trap, an ion cyclotron frequency ion trap and a quadrupole mass filter.

Shown in FIG. 7B is another hybrid IMS-MS system that makes use of trapped ion mobility separators like those described herein. In this embodiment, the transfer device 730, ion funnel 740, mass filter 770, fragmentation cell 780 and mass analyzer 790 are like those described above with regard to FIG. 7A. In this embodiment, however, two trapped ion mobility separator devices are used in the manner shown in FIG. 6B and described above. In particular, trapped ion mobility separator 711 operates as an ion trap, trapping the ions at different axial positions by ion mobility, as discussed above. The ions from the ion trap are output to a second trapped ion mobility separator 712, which operates as a mobility analyzer, separating the ions and eluting them in order of ion mobility. The eluted ions are coupled into an ion funnel 720 in which the ions are radially confined by a rotating electric field, and focused into ion transfer device 730. The remainder of the system shown in FIG. 7B operates in the same manner as the system of FIG. 7A, and the ion trap 711 and the trapped ion mobility separator 712 are operated at atmospheric pressure.

FIG. 7C shows a hybrid IMS-MS system that uses trapped ion mobility separators of the present invention. In this embodiment, the ion source 701, and trapped ion mobility separator devices 711 and 712 are the same as shown in FIG. 7B but, rather than exiting into an ion funnel, the output of trapped ion mobility separator 712 is directed to an ion gate 713. The ion gate is of a type known in the art, such as the ion gate shown in U.S. Pat. No. 10,241,079, and is used to select one or more ion species or to reduce the intensity of highly abundant ion species after their separation in the upstream trapped ion mobility separator 712. These selected/reduced ion species are then transferred to a first vacuum chamber 740, which includes an ion funnel and is operated in the same manner as the corresponding component of FIG. 7B. Within the vacuum portion of the system, the ions passing through the ion funnel are then analyzed using a low-pressure radio frequency (RF) TIMS system 760, which performs a final ion mobility separation of the selected/reduced ions. These separated ions are thereafter passed to mass filter 770, fragmentation cell 780 and mass analyzer 790, which operate in the manner described above with regard to FIG. 7B.

FIG. 7D shows an embodiment that is the same as the embodiment of FIG. 7C, except for the use of an activation/fragmentation cell 750 located between the first vacuum chamber 740 and the low-pressure radio frequency TIMS system 760. The activation/fragmentation cell 750 is a component that is known in the art, and that provides fragmentation or collision-induced activation of ions as described, for example, in US Patent Application Publication No. 2019/0265195 A1. Thus, it is the fragmented and/or activated ions that are eventually introduced to the low-pressure radio frequency TIMS system 760.

Shown in FIG. 7E is a hybrid IMS-MS system that uses trapped ion mobility separators like those described above. The ion source 701 is an atmospheric pressure ion source like the ion sources used in the embodiments of FIGS. 7A-7D, but additional ion sources 702 and 703 are also provided. Unlike ion source 701, these additional ion sources are operated in a vacuum environment, albeit with a pressure at or above 5,000 Pa (50 mbar). Different types of known ion sources may be operated at these pressures, such as a MALDI ion source or a sub-ambient electrospray ionization (ESI) source. The trapped ion mobility separator devices 711 and 712 are again used, respectively, as an ion trap and a mobility analyzer, but these components also reside in the same pressure environment as the ion sources 702, 703. The ions output from the trapped ion mobility separators 711, 712 are introduced to first vacuum chamber 740 which, along with mass filter 770, fragmentation cell 780 and mass analyzer 790, operate in the manner described above with regard to FIGS. 7A-7D.

1. A trapped ion mobility separator comprising:
an ion path along which ions travel from an entrance to an exit along a first axial direction relative to a central axis of the ion path, the ion path containing a gas through which the ions pass;
a first force-generating apparatus that exerts a first force on the ions in the first axial direction;
a second force-generating apparatus that exerts a second force on the ions in a second axial direction opposite to the first axial direction, wherein at least one of the first and second forces varies spatially along the first axial direction such that ions are trapped and separated by ion mobility along said first axial direction during an accumulation phase, and wherein at least one of the first and second forces is varied during an elution phase to increase a magnitude of the first force relative to the second force over time such that the ions are progressively driven to the exit of the ion path as a function of ion mobility; and
a rotating confinement field-generating apparatus that generates a radially-inhomogeneous electric potential that exerts a confinement force on the ions in a radial direction toward said central axis, relative maxima and minima of said electric potential rotating about said central axis as a function of time.

2. The trapped ion mobility separator according to claim 1, wherein the pressure of the gas in the ion path is higher than 5,000 Pa.

3. The trapped ion mobility separator according to claim 1, wherein the force that varies spatially along the first axial direction comprises a gradient along a first portion of the ion path that flattens to a plateau of substantially constant force in the vicinity of the exit of the ion mobility separator.

4. The trapped ion mobility separator according to claim 1, wherein the first force and second force are of different respective types, each being generated by one of a gas flow, an electric DC field and an axial component of the rotating confinement field.

5. The trapped ion mobility separator according to claim 1, wherein the trapped ion mobility separator is arranged such that such that
$${K}_{o} \frac{{p}_{o}}{p} \frac{T}{{T}_{o}} \frac{m}{q} ≪ {τ}_{R o F}$$
where p is pressure of the gas, pₒ is normal pressure, T is temperature of the gas, Tₒ=normal temperature, Kₒ is normalized ion mobility, m is mass, q is charge and τ_{RoF} is a time constant of the rotating confinement field which specifies how fast the rotating confinement field changes at a given position.

6. The trapped ion mobility separator according to claim 5, wherein the trapped ion mobility separator is arranged such that such that
$${K}_{o} \frac{{p}_{o}}{p} \frac{T}{{T}_{o}} \frac{{U}_{R o F}}{{f}_{R o F}} \leq {c}_{R o F}$$
where c_{RoF} is a confinement constant, Kₒ is normalized ion mobility, p is pressure of the gas, pₒ is normal pressure, T is temperature of the gas, Tₒ is normal temperature, U_{RoF} is the potential difference between the maxima and minima of the electric potential rotating about the central axis and f_{RoF} is the angular frequency of the rotating confinement field.

7. The trapped ion mobility separator according to claim 1, wherein the rotating confinement field-generating apparatus comprises a plurality of radially-segmented electrodes each having a minimum of four segments.

8. The trapped ion mobility separator according to claim 7, wherein each electrode has eight radial segments.

9. The trapped ion mobility separator according to claim 7, wherein one of two different electrical potentials is applied to each of the segments of each radially-segmented electrode, and wherein a distribution of the electrical potentials applied to the segments of each electrode is symmetric with respect to the central axis at any given point in time.

10. The trapped ion mobility separator according to claim 7, wherein one of two different electrical potentials is applied to each of the segments of each radially-segmented electrode, and wherein a distribution of the electrical potentials applied to the segments of each electrode is asymmetric with respect to the central axis at any given point in time.

11. The trapped ion mobility separator according to claim 1, further comprising an ion trap that is located upstream of the ion mobility separator and that comprises a rotating confinement field-generating apparatus that generates a radially-inhomogeneous electric field that exerts a confinement force on the ions in a radial direction toward a central axis of the ion trap, relative maxima and minima of said electric potential rotating about the central axis of the ion trap as a function of time.

12. The trapped ion mobility separator according to claim 1, further comprising an ion funnel that is located at the entrance or exit of the trapped ion mobility separator and that comprises a rotating confinement field-generating apparatus that generates a radially-inhomogeneous electric field that exerts a confinement force on the ions in a radial direction toward a central axis of the ion funnel, relative maxima and minima of said electric potential rotating about the central axis of the ion funnel as a function of time.

13. A method for analyzing ions using a trapped ion mobility separator comprising:
providing an ion path along which ions travel from an entrance to an exit of the separator along a first axial direction relative to a central axis of the ion path, the ion path containing a gas through which the ions pass;
generating a first force that acts on the ions in the first axial direction;
generating a second force that acts on the ions in a second axial direction opposite to the first axial direction, wherein at least one of the first and second forces varies spatially along the first axial direction such that ions are trapped and separated by ion mobility along said first axial direction;
varying at least one of the first and second forces to increase a magnitude of the first force relative to the second force over time such that the ions are progressively driven to the exit of the ion path and separated as a function of ion mobility; and
confining the ions using a rotating confinement field-generating apparatus that generates a radially-inhomogeneous electric potential that exerts a confinement force on the ions in a radial direction toward said central axis, relative maxima and minima of said electric potential rotating about said central axis as a function of time.

14. The method according to claim 13, wherein the separated ions are detected by an ion detector.

15. The method according to claim 13, wherein the separated ions are further analyzed as a function of mass in a mass analyzer located downstream of the trapped ion mobility separator.

16. The method according to claim 13, wherein the separated ions are fragmented into fragment ions and the fragment ions are further analyzed as function in a mass analyzer located downstream of the trapped ion mobility separator.

17. The method according to claim 16, wherein the separated ions are filtered according to mass prior to the fragmentation and/or selected prior to the fragmentation.

18. The method according to claim 13, wherein ions of specific ion mobility are selected, the selected ions are activated or fragmented in a downstream activation/fragmentation cell and the activated/fragmented ions are further analyzed according to ion mobility.

19. The method according to claim 13, wherein the trapped ion mobility separator is operated such that
$${K}_{o} \frac{{p}_{o}}{p} \frac{T}{{T}_{o}} \frac{m}{q} ≪ {τ}_{R o F}$$
where p is pressure of the gas, pₒ is normal pressure, T is temperature of the gas, Tₒ=normal temperature, Kₒ is normalized ion mobility, m is mass, q is charge and τ_{RoF} is a time constant of the rotating confinement field which specifies how fast the rotating confinement field changes at a given position.

20. The trapped ion mobility separator according to claim 19, wherein the trapped ion mobility separator is operated such that
$${K}_{o} \frac{{p}_{o}}{p} \frac{T}{{T}_{o}} \frac{{U}_{R o F}}{{f}_{R o F}} \leq {c}_{R o F}$$
where c_{RoF} is a confinement constant, Kₒ is normalized ion mobility, p is pressure of the gas, pₒ is normal pressure, T is temperature of the gas, Tₒ is normal temperature, U_{RoF} is the potential difference between the maxima and minima of the electric potential rotating about the central axis and f_{RoF} is the angular frequency of the rotating confinement field.

21. The method according to claim 13, wherein ions from an ion source are accumulated in an ion trap located upstream of the trapped ion mobility separator while ions which have been provided earlier from the ion source are analyzed in the trapped ion mobility separator.
